(19) United States
(12) Patent Application Publication
(10) Pub. No.: US 2024/0044498 A1
(43) Pub. Date: Feb. 8, 2024

(54) METHOD FOR DETERMINING THE COOKING END TIME OF FOOD, AND HOUSEHOLD COOKING APPLIANCE

(71) Applicant: BSH Hausgeräte GmbH, Munich (DE)

(72) Inventors: Julien Adam, Lingolsheim (FR); Kadir Nigar, Strasbourg (FR)

(21) Appl. No.: 18/265,728

(22) PCT Filed: Dec. 8, 2021
(86) PCT No.: PCT/EP2021/084786

§ 371 Date: Jun. 7, 2023

(30) Foreign Application Priority Data
Jan. 7, 2021 (EP) 21290001.3

(51) Int. Cl. F24C 7/08; G06T 7/00

(52) U.S. Cl. CPC F24C 7/085; G06T 7/0004; G06T 2207/30128

(57) ABSTRACT

In a method for determining a cooking end time of food located in a cooking chamber of a household cooking appliance, at the beginning of a cooking process a lightness value-separable image of the cooking chamber is created and segmented based of color coordinates thereof by way of cluster analysis to produce food pixels associated with the food and surrounding pixels associated with a surrounding area of the food. A user is offered an opportunity to enter a target degree of browning. During the cooking process images of the cooking chamber at intervals are recorded and a respective actual degree of browning is computed in these images based on the food pixels. The actual degree of browning is compared with the target degree of browning and the food is treated in the cooking chamber until the actual degree of browning has at least approximately reached the target degree of browning.

The invention relates to a method for determining a cooking end time of food located in a cooking chamber of a household cooking appliance, in which, at the beginning of a cooking process, a lightness value-separable image of the cooking chamber is created, a segmentation is carried out on the lightness value-separable image on the basis of its color coordinates, which produces food pixels associated with the food and surrounding pixels associated with the surrounding area of the food; a user is offered the opportunity to enter a target degree of browning; images of the cooking chamber are recorded at time intervals during a cooking process; an actual degree of browning in these images is calculated based on the food pixels; and the actual degree of browning is compared with the target degree of browning; and the food is treated in the cooking chamber until the actual degree of browning has reached the target degree of browning. The invention also relates to a household cooking appliance designed to carry out the method. The invention is particularly advantageously applicable to ovens.

EP 3 477 206 A1 discloses a cooking appliance, which comprises a cooking chamber and an imaging apparatus for acquiring an image of a foodstuff within the chamber. A data processing unit can be configured so that it computes a parameter for the foodstuff, which can be shown at a user interface, based on the image recorded.

WO 2019/091741 A1 discloses an oven which detects whether foodstuff located in a cooking chamber of said oven is cooked, wherein a control unit, which receives data provided by a sensor, establishes color data based on this data and, by interpreting said color data, determines whether the foodstuff is fully cooked. To do this, an RGB image of the cooking chamber is converted into an L*a*b image, in the (a*, b*) color layer upper and lower threshold values for the color coordinates a* and b* are specified, an averaged lightness value is computed for the pixels lying within the threshold values, the averaged lightness value is compared with a target browning value as a measure for a browning of the foodstuff.

The object of the present invention is to overcome, at least in part, the disadvantages of the prior art and in particular to provide an opportunity, with little computational effort, reliably to determine a cooking end time of a cooking process with the aid of a target degree of browning.

This object is achieved in accordance with the features of the independent claims. Preferred forms of embodiment are in particular to be taken from the dependent claims.

The object is achieved by a method for determining a cooking end time of food located in a cooking chamber of a household cooking appliance, in which
at the beginning of a cooking process a lightness value-separable image of the cooking chamber is created,
a segmentation is applied to the lightness value-separable image with the aid of the color coordinates by cluster analysis, which produces food pixels associated with the food and surrounding pixels associated with a surrounding area of the food,
a user is offered the opportunity of entering a target degree of browning and
during a cooking process images of the cooking chamber are recorded at time intervals, a respective actual degree of browning is computed in these images with the aid of the food pixels and the actual degree of browning is compared to the target degree of browning and
the food is treated in the cooking chamber until such time as the actual degree of browning has at least approximately reached the target degree of browning.

This method gives the advantage that food is able to be separated from surrounding pixels especially reliably with a comparatively small computing effort in a recorded image of food pixels. To do this the use of a cluster analysis is especially advantageous, since in this way, by contrast for example with a segmentation by—in particular fixed threshold values for the color coordinates—a significantly better distinction between food pixels and surrounding pixels is produced, in particular if the food has a similar color to its surrounding area, for example light brown food and baking parchment. This in its turn enables an actual degree of browning to be compared especially reliably with a target degree of browning. The method is advantageously able to be carried out independently of the knowledge of the type of food being treated in the cooking chamber.

The household cooking appliance can be an oven with at least one radiant heater (for example tubular heating element or IR emitter), a microwave oven, a steam cooker or any given combination thereof, for example an oven with a microwave and/or steam cooking function.

The fact that an image of the cooking chamber is created “at the beginning” of a cooking process comprises for example an image of the cooking chamber being recorded, by means of a camera for example, before the beginning of the cooking process, at the beginning of the cooking process or shortly after the beginning of the cooking process (for example within one minute).

A lightness value-separable image is understood as an image constructed from pixels, in which the color coordinates of the individual pixels are expressed as coordinates of a color space, in which a (“lightness value”) coordinate corresponds to a lightness. Such a color space can for example be the L*a*b*color space in accordance with EN ISO 11664-4 (also referred to as CIELAB or CIEL*a*b*) with the lightness component or coordinate L*.

The procedure of segmentation of the lightness value-separable image in particular comprises an automatic grouping of the pixels, in particular of all pixels, into a color layer of the color space, i.e. without considering the lightness coordinates, into two or more subgroups. Unlike in a simple segmentation by setting threshold values in the color layer, the cluster analysis enables an especially good image content-dependent separation between the food pixels and the surrounding pixels of the food to be achieved. As a result of the segmentation in particular an assignment of the pixels in the recorded image to the respective segments is obtained, so that it is known which of the image pixels are food pixels and which are surrounding pixels. This can be done for example on the basis of the knowledge that colors of a surrounding area of the food such as an oven muffle (for example color of the enamel) or of a food support are at least approximately known.

“Color coordinates” are understood as coordinates of the lightness value-separable image that are not or do not represent lightness value coordinates. In the L*a*b*color space this corresponds to the coordinates a* and b*, etc. All coordinates of a (full) color space (for example L*, a* and b*) are referred to below as “color space coordinates” to distinguish them from the color coordinates.

The fact that the lightness value-separable image undergoes a segmentation with the aid of the color coordinates thus comprises the segmentation in a “color layer” spanned by the color coordinates being undertaken, thus the segmentation only looks at or takes account of the values of the image pixels in this color layer.

The image recorded by a camera or an analog color image sensor can be present in its original form in a color space differing from a color space with independent lightness coordinates, for example as an RGB image, which makes it easier to use conventional color cameras for image recording. The recorded image is, if it is not present as a lightness value-separable image, converted pixel-by-pixel into a lightness value-separable image and thereby created. As an alternative the recorded image can also be recorded directly in the form of a lightness value-separable image and be created in this way. A possible embodiment is thus that an RGB image of the cooking chamber is recorded at the beginning of the cooking process and is converted into a lightness value-separable image.

The fact that a user is offered a choice of setting a degree of browning by entering a target degree of browning can comprise the user being offered a choice of color (selectable for example with the aid of brown colors on a screen or display) and/or being offered a choice with the aid of character strings (for example. “rare”, “medium” and “well done”, with the aid of a scale of numbers, for example between “0” and “10”, etc.). In an especially simple embodiment the color browning scale can be predetermined as fixed, for example based on a user entry for the type of food. As an alternative the color browning scale can be computed in advance on the basis of the initially recorded image, which gives an especially good estimation of the target degree of browning able to be achieved in the course of the cooking process.

The fact that images of the cooking chamber are recorded at time intervals during the cooking process in particular comprises images recorded during the cooking process being present similarly to the image recorded at the beginning or initially in a lightness value-separable color space, because their pixels are originally present in this color space or have been transformed into a lightness value-separable color space. This gives the advantage of being able especially reliably to detect the target degree of browning. In this case the actual degree of browning and the target degree of browning thus correspond to respective points in the lightness value-separable color space, including a value at the lightness value coordinate. In general however it is also possible to describe the target degree of browning as a color point in the originally recorded color space (for example the RGB color space) and to leave the images recorded during the cooking process (after the initial image) in the originally recorded color space. This saves on computing effort.

The fact that, in these images, a respective actual degree of browning is computed with the aid of the food pixels, especially comprises a value averaged over the respective color space coordinates of the food pixels being computed in these images and the actual degree of browning and the actual degree of browning corresponding to the color point with these averaged values.

The fact that the actual degree of browning is compared with the target degree of browning especially comprises a gap between the actual degree of browning and the target degree of browning being computed in the color space.

The fact that the target degree of browning is at least approximately reached corresponds to reaching a cooking end time. When the cooking end time is reached at least one action can be initiated, for example the cooking process is ended, a temperature of the cooking chamber is reduced to a temperature for keeping the food warm and/or a message is output to a user, for example a beep tone, a display on the screen 8 or a message on a user's mobile terminal.

The fact that the food is treated in the cooking chamber until the target degree of browning is at least approximately reached can comprise the food being treated in the cooking chamber until the gap between actual degree of browning and target degree of browning has reached or falls below a predetermined gap.

One embodiment is that at the beginning of the cooking process an RGB image of the cooking chamber is recorded and is converted—especially pixel-by-pixel—into an L*a*b* image. An L*a*b* representation has the advantage that a subsequent segmentation with the aid of just the color components (for L*a*b* or CIELAB of the color space components a* and b*) can be undertaken especially easily and reliably. The original recording as RGB image is advantageous since many commercially available cameras are RGB cameras.

The L*a*b*color space describes all perceivable colors. It uses a three-dimensional color space, in which the light or lightness coordinate L* is at right angles to the color layer (a*,b*). In this case the a* coordinate specifies the color type and color intensity between green and red and the b* coordinate the type of color and the color intensity between blue and yellow. The greater positive values of a* and b* are and the smaller negative values of a* and b* are, the more intensive the color tone becomes. If a*=0 and b*=0, an achromatic color tone is present on the lightness axis. In usual software conversions L* (lightness) can for example assume values of between 0 and 100 and a* and b* can be varied for example between −128 and 127. Consequently an automatic segmentation is only undertaken in the color layer (a*,b*).

One embodiment is that the segmentation is undertaken with the aid of a cluster analysis, in particular using a k-means-like algorithm. In this way the advantage is achieved that a simple to use and powerful algorithm for segmentation can be used, which for example needs little computing power compared to neural networks. In this case, in the (a*; b*) color layer considered, in particular two or more focal points are set on an arbitrary basis and then the pixels of the recorded image (in its lightness-separated color space representation) are assigned to the focal points with the aid of their color level coordinates. As a result, segments or groupings of similar pixels (of which the number corresponds to the number of the focal points) are formed. One development is that the k-means-like algorithm uses two focal points, which is especially advantageous for distinguishing between food pixels and surrounding pixels.

The k-means-like algorithm can be a k-means algorithm (as such) or an algorithm derived therefrom (for example a k-median, k-means++- or k-medoids algorithm etc.). The k-means algorithm can be implemented as a Lloyd algorithm or MacQueen's algorithm for example.

As an alternative the cluster analysis can be undertaken using an expected maximization algorithm. From one perspective the k-means algorithm can be seen as a special case of an expected maximization algorithm.

It is also possible to use a trained neural network for cluster analysis. The trained neural network can for example be what is known as a Convolutional Neural Network (also referred to as CNN or ConvNet), in particular a deep CNN (deep Convolutional Neural Network), advantageously a so-called deep convolutional semantic segmentation neural network. An example of such a network is what is known as SegNet, as is described for example in the article entitled “SegNet: A Deep Convolutional Encoder-Decoder Architecture for Image Segmentation” by Vijay Badrinarayanan, Alex Kendall, and Roberto Cipolla, IEEE Transactions on Pattern Analysis and Machine Intelligence, 2017. A development is that the cluster analysis with the aid of a trained neural network uses a trained GAN (“Generative Adversarial Network”), specifically a super-resolution GAN, known as an “SRGAN”, An example of an SRGAN is described for example in: “Photo-Realistic Single Image Super-Resolution Using a Generative Adversarial Network”, Christian Ledig et al., IEEE Conference on Computer Vision and Pattern Recognition (CVPR), July 2017.

One embodiment is that, for segmentation, the k-means-like algorithm is followed by an opening operation in a color layer of the lightness value-separable image. This achieves the advantage that noise of the food pixels is suppressed in the recorded image, since pixels associated with areas affected by noise are removed from the segmentation or grouping and no longer considered. An “area affected by noise” can be understood as an area in the recorded image in which food pixels and surrounding pixels are largely present non-contiguous (“noisy”) so that this area cannot be assigned reliably either to the food or to the surrounding area. In this way the advantage is again obtained that image areas can be especially reliably allocated to the food, since unsharp or fraying edge areas are eliminated. To carry out the opening operation so-called erosion and/or and dilatation operators can be used for example in the basically known way.

An embodiment in addition to or as an alternative to using the k-means-like algorithm consists of carrying out the segmentation by means of a user-guided region-growing algorithm. This advantageously makes possible a reliable separation of food and surrounding pixels, since the food area is recognized by a user and can be entered at the household cooking appliance. This is for example especially useful when the automatic segmentation is undertaken using only two focal points and the food lies on a baking parchment and the color of the baking parchment is far closer to the color of the food than the baking sheet or when foods with far different colors have been placed in the cooking chamber.

In this embodiment a user can for example be shown the recorded image (in the full color space) and can be offered the option of identifying specific pixels or image areas as associated with the food, for example by tapping on the image areas on a touchscreen or by selecting them by means of a cursor. Then, by means of the region growing algorithm in the color layer (for example the (a*; b*) color layer) a surface area is defined around the point of contact or area of contact, of which the pixels have the same or a similar color to the color of the contact point or area of contact, and the pixels located on this surface are categorized as food pixels. This can be implemented for example so that a check is made whether a pixel adjacent to the image area or pixel selected on the user side is located in the color layer within a predetermined radius R from the color point of the pixel or a color point that corresponds to the average of the color points of the area of contact. If this is the case, the adjacent pixel is allocated to the food, otherwise to the surrounding area. The region growing algorithm is continued with a check of the pixels then adjacent to the included pixels until such time as no pixels fulfill this condition that they lie within a predetermined radius R. The surface expanded in this way can be displayed to the user in the image, and the user can then discard the surface and/or define image areas or pixels as associated with the food. One development is that the user can adapt the radius R in order to generate the surface as more sensitive (smaller R) or less sensitive (larger R).

One development is that the segmentation by the k-means-like algorithm is followed or can be followed by a user-guided region growing algorithm. In this way the advantage is obtained that incorrect or non-assigned image areas or pixels can be corrected or inserted by a user by means of the k-means-like algorithm: if for example a specific image area has been computed by the k-means-like algorithm as the surrounding area although it shows food, the user can assign the region to the food by the region growing algorithm. Conversely the user can assign an image area incorrectly assigned to the food by the k-means-like algorithm to the surrounding area by the region growing algorithm.

One development is that the segmentation is repeated in the course of the cooking process. Through this the advantage is achieved that for example a movement, volume change etc. of the food can be taken into consideration, for example after predetermined intervals. In this way the actual degree of browning can be determined especially reliably.

One embodiment is that, based on the averaged color space coordinates of the food pixels of the initially recorded lightness value-separable image (for example the coordinates L*, a* and b* of the L*a*b* color space) and with the aid of real browning curves stored in a database for different foods, a browning curve (predicted browning curve) is computed for the current food. In this way the advantage is obtained that a well-suited predicted browning curve of the current food to be cooked is able to be created for many application cases even without knowledge of the type of the current food to be cooked. The real browning curves advantageously extend from uncooked to fully cooked, possibly even to overcooked.

The predicted browning curve can for its part be used for example to offer a user a selection of various target degrees of browning defined by the points of the predicted browning curve adapted to the food. To this end a user can for example be offered an opportunity to enter a target degree of browning with the aid of color fields, which are filled with colors of spaced points of the predicted browning curve. A predicted browning curve is in particular understood as the computed, (predicted) development of the degree of browning of the food surface of the current food lying at a point in the future in the color space. The database can be a component of the cooking appliance or can be kept in an external entity able to be coupled for communication to the cooking appliance, such as a network server or Cloud storage.

One embodiment is that the predicted browning curve is computed in that, for the individual points (in time) of the predicted curve, a linear equation system is created that links them via matrix factors to the initial averaged color space coordinates of the food pixels and in that the matrix factors are determined by means of one of the averaged color space coordinates—in particular a linear color space coordinate—of the food pixels of the real browning curves stored in the database.

For example the color points F(L*, a*, b*) of the predicted browning curve in the color space can be computed for the current food with the aid of the linear equation system for the L*a*b* color space for the points in time ti=t1, . . . , tn with the aid of the linear equation system

$$F ( t 1 ) = {k}_{11} ( t 1 ) \cdot {\overline{L}}_{i n i t}^{*} + {k}_{12} ( t 1 ) \cdot {\overline{a}}_{i n i t}^{*} + {k}_{13} ( t 1 ) \cdot {\overline{b}}_{i n i t}^{*} + {k}_{14} ( t 1 )$$

$$F ( t 2 ) = {k}_{11} ( t 1 ) \cdot {\overline{L}}_{i n i t}^{*} + {k}_{12} ( t 2 ) \cdot {\overline{a}}_{i n i t}^{*} + {k}_{13} ( t 2 ) \cdot {\overline{b}}_{i n i t}^{*} + {k}_{14} ( t 2 )$$

$$⋮$$

$$F ( tn ) = {k}_{11} ( tn ) \cdot {\overline{L}}_{i n i t}^{*} + {k}_{12} ( tn ) \cdot {\overline{a}}_{i n i t}^{*} + {k}_{13} ( tn ) \cdot {\overline{b}}_{i n i t}^{*} + {k}_{14} ( t n )$$

wherein L̅^{*}ᵢₙᵢₜ init corresponds to the L* value averaged from the initially recorded (i.e. at point in time t0) lightness value-separable image of the current food over the food pixels, ā^{*}ᵢₙᵢₜ corresponds to the a* value from the initially recorded lightness value-separable image averaged over the food pixels, b̅^{*}ᵢₙᵢₜ corresponds to the b* value averaged from the initially recorded lightness value-separable image over the food pixels, and k are matrix coefficients. The matrix coefficients k are computed by means of mathematical regression analysis from the real browning curves stored in the database. Thus a predicted browning curve with the color points {L̅^{*}ᵢₙᵢₜ, ā^{*}ᵢₙᵢₜ, b̅^{*}ᵢₙᵢₜ}, . . . , {L̅^{*}(tn), ā^{*}(tn), b̅^{*}(tn)} can be computed in advance for the current food for the points in time ti=t1, . . . , tn or for the steps i=1, . . . , n.

A user can now be offered for selection a choice of target degrees of browning under the color points {L̅^{*}ᵢₙᵢₜ, ā^{*}ᵢₙᵢₜ, b̅^{*}ᵢₙᵢₜ}, . . . , {L̅^{*}(tn), ā^{*}(tn), b̅^{*}(tn)}, with the aid of the degrees for the predicted browning curve. In this case all computed browning points of the predicted browning curve, a selection of the computed degrees of browning or — for example by interpolation to color points which lie between computed degrees of browning of the predicted browning curve—more than the computed degree of browning can be displayed to a user in color in color fields. The display of individual target degrees of browning on a screen as respective color fields or boxes, i.e. not as a continuous or quasi-continuous scale, makes it easier for a user advantageously to select a degree of browning, since, by contrast with a continuous or quasi-continuous scale, a degree of browning can reliably apply.

One development is that individual target degrees of browning are displayed on a screen as respective color fields or boxes and a user is offered the opportunity to display additional fields of target degrees of browning, which lie between the previously displayed degrees of browning. In this way a simple choice can advantageously be combined with a variably increased number of target degrees of browning. The boxes can be displayed assigned to a corresponding character string, and this can be in the vicinity of the color fields or in the color fields.

An especially advantageous embodiment for a user-friendly selection is that, in addition or as an alternative, the user is offered the opportunity of entering a target degree of browning with the aid of character-based descriptions of target degrees of browning, for example with the aid of texts such as “rare”, “medium”, “well-done” or with the aid of numbers such as “1”, . . . , “10”. The characters can thus comprise letters and/or digits. One development is that target degrees of browning are only displayed on the screen by means of characters, i.e. without a color display of the selectable target degrees of browning.

One development is that when the option to select the target degree of browning is offered, the originally recorded image is additionally displayed. In this case it is an embodiment that with the selection of a target degree of browning by a user the food in the image is displayed as browned with the selected target degree of browning, for example in the sense of a “virtual reality”. Then the higher the selected target degree of browning is, the browner is the food displayed, etc.

One development is that a user, instead of the originally recorded image (for example with a Hawaiian pizza as the current food) retrieves real images and/or real browning curves of a food that is the same or similar (for example a Margherita pizza) with different real degrees of browning from a database and selects the target degree of browning by selecting an image from the number of images with different degrees of browning retrieved from the database. For the images retrieved from the database a respective degree of browning is stored, which can then be accepted as the target degree of browning of the current food. As an alternative the degrees of browning of these images can be computed for carrying out the method. This development gives the advantage that the target degree of browning can be determined with the aid of recorded images of real browned food, which show a more realistic picture of the food than a simple computed overlay of a degree of browning of the still unbrowned current food.

With the final entry of a target degree of browning (for example confirmation of a target degree of browning) by a user the food is treated in one embodiment in the cooking chamber until such time as a gap between the target degree of browning in the color space and an averaged current actual browning value has exceeded a minimum. To this end, in a development at predetermined, in particular regular, intervals an image of the food is recorded, with the aid of the food pixels an average image point in the lightness value-separable color space is formed and compared to the target degree of browning (i.e. to the color point in the color space corresponding to the target degree of browning). This embodiment is particularly advantageous when the actual degree of browning does not precisely reach the target degree of browning, so that then the cooking process—at a slightly later time than the ideal abort point—is still aborted when the actual degree of browning has reached the target degree of browning “as well as possible”.

One embodiment is that, after the beginning of the cooking process, images of the current food are recorded at predetermined time intervals, from these images with the aid of the food pixels the actual degree of browning of the food is determined, with the aid of the actual degree of browning, the predicted browning curve for the current food is computed again and from the predicted browning curve for the current food the target degree of browning is adapted. The advantage achieved in this way is that then, when it is recognized with the aid of current images that the predicted browning curve markedly deviates from the initially computed predicted browning curve, the target degree of browning can be adapted according to the apparent wishes of the customer. The target degree of browning can be adapted with or without user confirmation or new user entry.

The “newly” computed predicted browning curve can for example likewise be computed by means of the linear equation system described above and a regression method, wherein then the values of the color space coordinates L*, a* and b* for the already recorded images are known. If for example, before re-computation of the predicted browning curve, 10 images have already been recorded at times t1, . . . , t10, the above equation system can be formulated as

$$F ( t 1 ) = {k}_{11} ( t 1 ) \cdot {\overline{L}}^{*} ( t 1 ) + {k}_{12} ( t 1 ) \cdot {\overline{a}}^{*} ( t 1 ) + {k}_{13} ( t 1 ) \cdot {\overline{b}}^{*} ( t 1 ) + {k}_{14} ( t 1 )$$

$$F ( t 2 ) = {k}_{11} ( t 2 ) \cdot {\overline{L}}^{*} ( t 2 ) + {k}_{12} ( t 2 ) \cdot {\overline{a}}^{*} ( t 2 ) + {k}_{13} ( t 2 ) \cdot {\overline{b}}^{*} ( t 2 ) + {k}_{14} ( t 2 )$$

$$⋮$$

$$F ( t 10 ) = {k}_{11} ( t 10 ) \cdot {\overline{L}}^{*} ( t 10 ) + {k}_{12} ( t 10 ) \cdot {\overline{a}}^{*} ( t 10 ) + {k}_{13} ( t 10 ) \cdot {\overline{b}}^{*} ( t 10 ) + {k}_{14} ( t 10 )$$

$$F ( t 11 ) = {k}_{11} ( t 11 ) \cdot {\overline{L}}_{i n i t}^{*} + {k}_{12} ( t 11 ) \cdot {\overline{a}}_{i n i t}^{*} + {k}_{13} ( t 11 ) \cdot {\overline{b}}_{i n i t}^{*} + {k}_{14} ( t 11 )$$

$$⋮$$

$$F ( tn ) = {k}_{11} ( tn ) \cdot {\overline{L}}_{i n i t}^{*} + {k}_{12} ( tn ) \cdot {\overline{a}}_{i n i t}^{*} + {k}_{13} ( tn ) \cdot {\overline{b}}_{i n i t}^{*} + {k}_{14} ( t n )$$

wherein the values of the color space coordinates L̅^{*}(t1), . . . , b̅^{*}(t10) for the times t1, . . . , t10 are known. The matrix coefficients k are again able to be found by a regression analysis by using the real browning curves stored in the database.

For example in this way, when the new computed predicted browning curve is shorter than the initially computed predicted browning curve (i.e. does not include most of the brown color space points of the initially computed predicted browning curve), a target degree of browning selected by a user is shifted relative to a ratio of the lengths of the two predicted browning curves to the “new” predicted browning curve. If the initially computed predicted browning curve was 10 units long for instance, wherein degrees of browning between “1” and “10” could be selected by a user (with “0” being the uncooked food), the new predicted browning curve however only has degrees of browning that correspond to degrees of browning “1” to “8” of the initially computed predicted browning curve, a new target degree of browning “6” on the new predicted browning curve is selected, which corresponds in its color to the target degree of browning “5” selected with the aid of the originally computed predicted browning curve.

In another example the target degree of browning selected with the aid of the initially computed predicted browning curve is no longer achieved. This can be the case for example when the food currently being cooked remains comparatively light in color even after a longer period of cooking (for example fish), but a user has selected a comparatively brown target degree of browning with the aid of the initially computed predicted browning curve (independent of the type of the current food). In this case for example a message or a signal can be output to the user that their desired target degree of browning is not able to be achieved and the user can then, with the aid of the new predicted browning curve, enter a new target degree of browning. As an alternative or in addition a target degree of browning (for example medium) selected with the aid of the initially computed predicted browning curve can be adapted automatically to the new predicted browning curve.

The object is also achieved by a household cooking appliance, having a cooking chamber, at least one camera directed into the cooking chamber, a graphical user interface as well as a data processing facility, wherein the household appliance is configured:
to create by means of the at least one color image sensor a lightness value-separable image of the cooking chamber at the beginning of a cooking process,
to carry out a segmentation with the aid of the data processing facility on the lightness value-separable image with the aid of the non-lightness color coordinates, which produces food pixels associated with the food and surrounding pixels associated with a surrounding area of the food,
to offer to a user via the graphical user interface the opportunity to enter a target degree of browning and
to record images of the cooking chamber by means of the data processing facility at intervals during a cooking process, to compute in these images with the aid of the food pixels a respective actual degree of browning and to compare the actual degree of browning with the target degree of browning and
the food is treated in the cooking chamber until the actual degree of browning has at least approximately reached the target degree of browning.

The household cooking appliance can be embodied similarly to the method and vice versa and has the same advantages.

Food introduced into the cooking chamber can be treated by means of at least one food treatment facility, for example by heat radiation (created by a tubular heating element for example, IR radiator etc.), microwaves (created by a microwave generator) and/or steam, in particular superheated steam (created by a vaporizer for example).

The at least one color image sensor can comprise at least one color camera which is sensitive to the visible spectrum and pixel-resolving or another color image sensor. The color image sensor can in particular create original RGB images.

The graphical user interface can for example comprise a color screen which can be actuated by a cursor and/or is touch-sensitive (touchscreen).

A lightness value-separable image of the cooking chamber being able to be created at the beginning of a cooking process by means of the at least one color image sensor can comprise a lightness value-separable image originally being created by the color image sensor or a non-lightness value-separable image (for example RGB image) originally being created by the color image sensor which is transformed or converted by means of the data processing facility into a lightness value-separable image.

The characteristics, features and advantages of this invention described above and also the manner in which these are achieved will become clearer and easier to understand in conjunction with the following schematic description of an exemplary embodiment, which will be explained in greater detail in conjunction with the drawings.

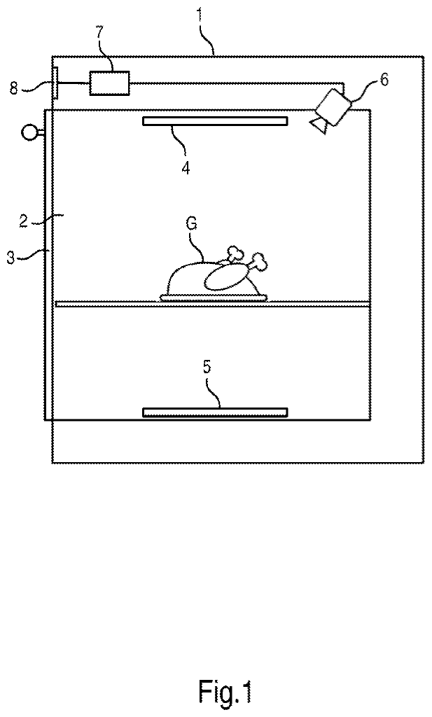

FIG. 1 shows a sectional diagram in a side view of a sketch of a household cooking appliance;

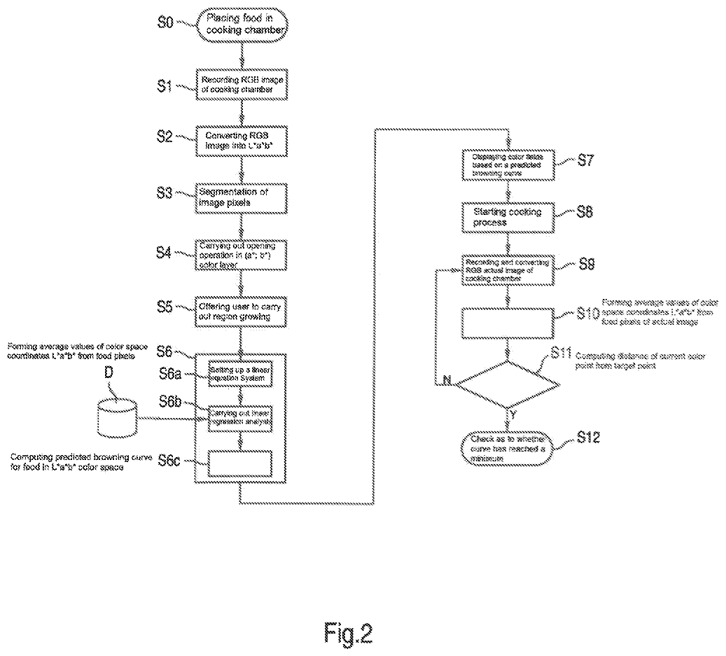

FIG. 2 shows a possible execution sequence of a method for determining a cooking end time of food located in a cooking chamber of the household cooking appliance from FIG. 1;

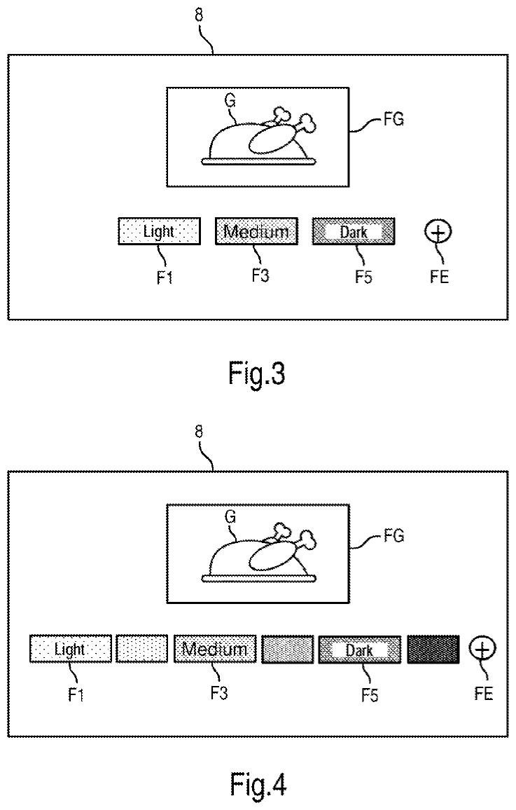

FIG. 3 shows an overhead view of a screen 8 of the household cooking appliance from FIG. 1, which is designed with three color fields for selection of a target degree of browning; and

FIG. 4 shows an overhead view of a screen 8 of the household cooking appliance from FIG. 1, which is designed with six color fields for selection of a target degree of browning.

FIG. 1 shows a household cooking appliance in the form of an oven 1 with a cooking chamber 2, of which the loading opening on the front side is able to be closed off by a door 3. The cooking chamber 2 is able to be heated here by heat radiators in the form of upper heating element 4 and lower heating element 5 illustrated by way of example. Here by way of example on the roof side is an RGB color image camera 6 directed into the cooking chamber 2, through which RGB images of the cooking chamber 2, including of food G present therein, are able to be recorded. The camera 6 is coupled for data processing to a data processing facility 7, wherein the data processing facility 7 is moreover coupled for data processing with a graphical user interface in the form of a color screen 8. The household cooking appliance can also have means of illumination for illuminating the cooking chamber 2 (not shown).

FIG. 2 shows a possible execution sequence of a method for determining a cooking end time of food G located in a cooking chamber of the oven 1.

In a step S0 the food G is placed in the cooking chamber 2 and the execution of the method is started via the screen 8 or via another actuation facility of the oven 1.

In a step S1 an RGB image of the cooking chamber, which also shows the food G, is recorded by means of the camera 5 and transmitted to the data processing facility 7.

In a step S2 the RGB image is converted by means of the data processing facility 7 into an L*a*b* image.

In step S3 in the (a*; b*) color layer with the aid of the a* and b* color coordinates of the image, a segmentation of the pixels of the image by means of a k-means algorithm with two focal points is carried out by means of the data processing facility 7. Each of the pixels is thereby classified as a food pixel or as a surrounding pixel.

In a step S4 an opening operation is carried out by means of the data processing facility 7 in the (a*; b*) color layer. Through this, pixels present in areas of the image affected by noise are from the groups of the food pixels and surrounding pixels.

In a step S5 a user is offered the opportunity via the screen 8 of carrying out a region growing and, if the user uses this, it is executed. This enables pixels previously classified as surrounding pixels to be regrouped under user control as food pixels, or vice versa.

In a step S6 by means of the data processing facility 7 average values of the three color space coordinates L*, a* and b* are formed from the food pixels, namely L̅^{*}ᵢₙᵢₜ, ā^{*}ᵢₙᵢₜ and b̅^{*}ᵢₙᵢₜ, and from these a linear equation system is set up (step S6a). Following this, in a step S6b, a linear regression analysis is carried out by means of the data processing facility 7 with the aid of the linear equation system and with the aid of real browning curves of different foods retrieved from a database D (within the device or external to it), which gives the matrix coefficients of the linear equation system. In a following step S6c a predicted browning curve for the food G in the L*a*b*color space is computed by means of the data processing facility 7 with the aid of the linear equation system.

In a step S7 a number of color fields are displayed to the user on the color screen 8, of which the colors correspond to spaced points of the predicted browning curve and thus to different target degrees of browning, as shown for example in FIG. 3. In addition the color fields can be identified by text and/or numbers, e.g. “rare”, “medium” and “well-done” or “1” to “10”. The user can now select a specific target degree of browning, for example by touching a desired color field or by a corresponding cursor operation. The target degree of browning corresponds to a corresponding target point F_{target}={L*_{target}, a*_{target}, b*_{target}} in the L*a*b*color space.

FIG. 3 further shows the option of selecting the target degree of browning with the aid of color fields F1, F2, F5 defined on the color screen 8, which are filled homogeneously in each case with one of the colors of the predicted browning curve, here with an increasing target degree of browning. The individual points of the predicted browning curve thus correspond to respective degrees of browning. The user can select a target degree of browning by tapping on a color field F1, F2 or F5 and subsequently confirm where necessary.

Descriptive texts are also present in the color fields F1, F2, F5, here: “light” for little cooked food G, “medium” for medium-brown cooked food G and “dark” for well-cooked or dark cooked food G. The descriptive texts can however also be arranged outside the color fields, for example below them or above them.

Optionally a field FG for displaying an image of the food G can also be present on the color screen 8, for example the image originally recorded or an image recorded during the cooking process. The latter case can occur for example when the target degree of browning is to be computed with the aid of a new predicted browning curve, as has already been described above and will be described in greater detail further below. Optionally then, when the user selects one of the color fields F1, F3, F5, the food G can be shown in this color so that its color corresponds to the associated target degree of browning, for example by way of a type of virtual reality adaptation.

A field FE is further defined on the color screen 8 that, when actuated, displays additional target degrees of browning, as shown in FIG. 4 with the aid of the additional color fields F2, F4 and F6.

Following on from a confirmed selection of a target degree of browning by a user in step S7, in step S8, the cooking process is started by activating the upper heating element 4 and/or the lower heating element 5.

Then, in a step S9, an RGB actual image of the cooking chamber 2 is recorded by the camera at a point in time ti of the cooking process and converted into an L*a*b* image.

In a step S10, with the aid of the food pixels of the actual image recorded at point in time ti of the cooking process, average values of the three color space coordinates L*, a* and b* are formed, namely L̅^{*}(ti), ā^{*}(ti) and b̅^{*}(ti), which corresponds to an actual degree of browning in the form of an actual color point F ti)={L̅^{*}(ti), ā^{*}(ti), b̅^{*}(ti)} in the L*a*b*color space.

In a step S11 a distance of the current color point F (ti) of the last recorded image from the target point F_{target} in the L*a*b*color space is computed. It is furthermore checked whether the—where necessary coordinate-dependent—distance is reaching a predetermined value or is falling below it. If this is not the case (“N”, the actual degree of browning of the food G is still comparatively far from the target degree of browning), the method branches back to step S9. In this case consecutive images are recorded, in particular at regular intervals (for example every 10 s, 30 s or 60 s) by the camera 5.

If on the other hand this is the case (“Y”), in a step S11 at least one action is initiated, for example the cooking process is ended, a temperature of the cooking chamber is reduced to a temperature to keep the food warm and/or a message is output to the user (for example a beep tone, a display on the screen 8 or a message on a user's mobile device).

As an alternative or in addition, in step S11 a graph of the intervals of the actual color points F(ti) is recorded, wherein in the alternative version there does not need to be a check on whether a predetermined value has been reached or undershot. Then, in step S12, as an alternative or in addition, a check is made as to whether the curve has reached a minimum. If this is not the case (“N”) a branch is made back to step S9, otherwise (“Y”) the method goes to step S12.

Not shown but optional is the opportunity to check how frequently for example the steps S9 to S11 have been carried out and the predicted browning curve is recomputed at regular intervals (for example every 10, 20, 50 or 100 passes or every 5 min, 15 min or 30 min) in a similar way to step S6, wherein however in the linear equation system, instead of the average values of the color space coordinates L̅^{*}ᵢₙᵢₜ, ā^{*}ᵢₙᵢₜ and b̅^{*}ᵢₙᵢₜ, the average values of the color space coordinates L̅^{*}(ti), ā^{*}(ti), b̅^{*}(ti) of the recorded images at the corresponding steps or points in time ti are then employed, if present for the corresponding steps or points in time ti, as described above. A new predicted browning curve is then produced. This option can follow on from a step similar to step S7, in which the user can adapt their target degree of browning with the aid of the new predicted browning curve. As an alternative the target degree of browning can be adapted automatically. The option of adapting the target degree of browning can in one development in particular only be offered and where necessary carried out when the new predicted browning curve deviates markedly from the previously computed predicted browning curve, for example because the curve deviation (computed for example with the aid of the least squares method) exceeds a predetermined measure and/or because the previously set target degree of browning is no longer contained in the new predicted browning curve.

Since the cooking process is already underway, step S8 is subsequently skipped, and the method goes directly to step S9.

Naturally the present invention is not restricted to the exemplary embodiment shown.

In general “a”, “an” etc. can be understood as a single item or as a number of items, in particular in the sense of “at least one” or “one or more” etc., provided this is not explicitly excluded, for example by the expression “precisely one” etc.

Also a numerical specification can comprise precisely the number specified or also a usual tolerance range, provided this is not explicitly excluded.

### LIST OF REFERENCE CHARACTERS

1 Oven
2 Cooking chamber
3 Door
4 Upper heating element
5 Lower heating element
6 RGB color camera
7 Data processing facility
8 Color screen
D Database
G Food
S1-S12 Method steps

1-15. (canceled).

16. A method for determining a cooking end time of food located in a cooking chamber of a household cooking appliance, the method comprising:
creating at the beginning of a cooking process a lightness value-separable image of the cooking chamber;
carrying out a segmentation of the lightness value-separable image based on color coordinates thereof by way of cluster analysis to produce food pixels associated with the food and surrounding pixels associated with a surrounding area of the food;
offering a user an opportunity to enter a target degree of browning;
recording during the cooking process images of the cooking chamber at intervals;
computing in these images based on the food pixels a respective actual degree of browning;
comparing the actual degree of browning with the target degree of browning; and
treating the food in the cooking chamber until the actual degree of browning has at least approximately reached the target degree of browning.

17. The method of claim 16, further comprising:
recording at the beginning of the cooking process an RGB image of the cooking chamber; and
converting the RGB image into the lightness value-separable image.

18. The method of claim 17, further comprising:
converting the RGB image into an L*a*b* image, with L* being a lightness component and a* and b* being color components; and
segmenting the L*a*b* image based on the color components a* and b*.

19. The method of claim 16, wherein the segmentation is carried out via the cluster analysis by using a k-means-like algorithm.

20. The method of claim 19, further comprising following the segmentation by the k-means-like algorithm by an opening operation.

21. The method of claim 19, further comprising following the segmentation by the k-means-like algorithm by a user-guided region growing algorithm.

22. The method of claim 16, further comprising repeating the segmentation in the course of the cooking process.

23. The method of claim 16, further comprising:
computing a predicted browning curve for a current food based on averaged color space coordinates of food pixels of an initially recorded lightness value-separable image and with the aid of real browning curves stored in a database for different foods; and
offering the user an opportunity to enter the target degree of browning with the aid of color fields having colors which correspond to spaced points of the predicted browning curve.

24. The method of claim 23, wherein the predicted browning curve is computed by creating for individual points of the predicted browning curve a linear equation system that links the individual points via matrix factors to an initial averaged color space coordinates of the food pixels, and further comprising determining the matrix factors using a regression analysis from the averaged color space coordinates of the food pixels of the real browning curves stored in the database.

25. The method of claim 23, further comprising:
after the beginning of the cooking process, recording images of the current food at predetermined intervals;
determining the actual degree of browning of the food from the images with the aid of the food pixels;
recomputing the predicted browning curve for the current food based on the actual degree of browning; and
adapting the target degree of browning from the predicted browning curve.

26. The method of claim 16, wherein the user is offered the opportunity of entering the target degree of browning based on target degrees of browning described on a character basis.

27. The method of claim 16, further comprising offering real images of the food or of a similar food with different degrees of browning retrieved from a database for selection of the target degree of browning.

28. The method of claim 27, wherein the user is offered the opportunity of entering the target degree of browning by displaying the originally recorded image and displaying the food in the image as browned with the target degree of browning upon selection of the target degree of browning by the user.

29. The method of claim 16, wherein the food is treated in the cooking chamber until a distance between the target degree of browning in a color space from a current actual browning value has passed through a minimum.

30. A household cooking appliance, comprising:
a cooking chamber;
a color image sensor directed into the cooking chamber and designed to create at a beginning of a cooking process a lightness value-separable image of the cooking chamber;
a graphical user interface designed to offer a user an opportunity of entering a target degree of browning; and
a data processing facility designed to execute a segmentation on the lightness value-separable image by cluster analysis based on color coordinates thereof to produce food pixels associated with the food and surrounding pixels associated with a surrounding area of the food, to record temporally spaced images of the cooking chamber during the cooking process, to compute in these images based on the food pixels a respective actual degree of browning, and to compare the actual degree of browning with the target degree of browning,
wherein the food is treated in the cooking chamber until the actual degree of browning has at least approximately reached the target degree of browning.
